(19) United States
(12) Patent Application Publication
(10) Pub. No.: US 2023/0012191 A1
(43) Pub. Date: Jan. 12, 2023

(54) MUSICAL INSTRUMENT STRUCTURE WITH APPLAUSE SOUND

(71) Applicants: Arman TOMURCUK, Istanbul (TR); STANBUL ZÍLCÍLER MÜZÍK ALETLERÍ ÍMALATI SANAYÍ SANAYÍ VE TÍCARET LÍMÍTED SÍRKTÍ, Istanbul (TU)

(72) Inventor: Arman TOMURCUK, Istanbul (TR)

(73) Assignees: Arman TOMURCUK, Istanbul (TR); STANBUL ZÍLCÍLER MÜZÍK ALETLERÍ ÍMALATI SANAYÍ SANAYÍ VE TÍCARET LÍMÍTED SÍRKTÍ, Istanbul (TR)

(21) Appl. No.: 17/779,563

(22) PCT Filed: Apr. 7, 2020
(86) PCT No.: PCT/TR2020/050282

§ 371 Date: May 25, 2022

(30) Foreign Application Priority Data
Nov. 27, 2019 (TR) 2019/18599

(51) Int. Cl. G10D 13/063

(52) U.S. Cl. CPC G10D 13/063

(57) ABSTRACT

The present invention is a musical instrument structure (1) that produces applause sound effect to be used in the category of percussion instruments in the music sector, characterized in that; it comprises at least two cymbals (10) which are located on top of each other by means of centering thereof through the connection holes (11), are aligned such that the diameters of the cymbals (10) reduce from bottom to top, an inclined form (12) which allows for overlapping of the cymbals (10) with each other and for producing applause sound effect.

### TECHNICAL FIELD OF THE INVENTION

The present invention relates to a musical instrument structure comprising two, three, four, five or more cymbals to make applause sound to be used in the category of percussion category in the music industry.

### STATE OF THE ART

Today, alternative and original activities pose great importance in the performance arts in particular. For this reason, every artist or performers performing their arts in any field of art go after their unique performances. Artists try to achieve maximum efficiency by pushing not only their limits but also the tools and the devices that they use. This applies to musical instruments as well. Designing novel musical instruments in a manner in which they are conducted away from their traditional structures shall not only allow musicians to exhibit more unique performances but also enable them to generate different and unique sounds. The invention subject to the description provided herein is a musical instrument structure with applause sound for supporting the descriptions above.

Computer and electronic media support are used so as to create applause sound in the music performed with instruments known in the state of the art. However, the sound of applause generated in this manner sounds rather artificial and not very natural. Moreover, it fails to substitute the acoustic tone.

Consequently, there is an obvious need for a novel musical instrument structure that surpasses the state of the art and that constitutes an alternative.

### BRIEF DESCRIPTION OF THE INVENTION

The present invention relates to a musical instrument structure that surpasses the state of the art and provides additional advantages.

The aim of the present invention is to provide a musical instrument structure that allows for generating applause sound in acoustic tone in natural ways without any computer or electronic medium support.

Another aim of the present invention is to provide a musical instrument structure that can be composed of double, triple or quinary numbers of cymbals that are located on top of each other and are produced specifically for this aim and make applause sound.

Another aim of the present invention is to provide a novel musical instrument that can produce applause sound like a sound effect, in addition to the sounds which are required to be present in a drum set.

Another aim of the present invention is to provide a novel musical instrument for the use of the musicians who attach particular importance to the acoustic sounds and desire to generate applause sound without using computer support.

To achieve all of the aforementioned aims that shall become evident through the detailed description provided below, the present invention is a musical instrument structure that produces applause sound effect to be used in the category of percussion instruments in the music sector, characterized in that; it comprises at least two cymbals which are located on top of each other by means of centering thereof through the connection holes, are aligned such that the diameters of the cymbals are reduced from bottom to top, an inclined form which allows for overlapping of the cymbals with each other and for producing applause sound effect.

### DESCRIPTION OF THE FIGURES

The present invention shall be described by making references to the accompanying drawings, thereby ensuring that the characteristics of the invention are understood more clearly. However, the aim of herein is not to limit the present invention with specific embodiments. On the contrary, it is aimed to cover all alternatives, modifications and equivalents which may be contained in the field defined by the pending patent claims. It is to be understood that; the details described herein are only provided for the sake of illustrating the preferred embodiments of the present invention as well as for illustrating the methods and describing the principles of the invention and the conceptual features of the invention. Wherein;

FIG. 1 illustrates the perspective view of the model of the inventive musical instrument structure consisting of five cymbals.

FIG. 2 illustrates the exploded view of the model of the inventive musical instrument structure consisting of five cymbals.

FIG. 3 illustrates the perspective view of the model of the inventive musical instrument structure consisting of three cymbals.

FIG. 4 illustrates a perspective view of the model of the inventive musical instrument structure consisting of two cymbals.

The figures which enable the clarification of the present invention are enumerated as mentioned in the attached figures and they are given with their names below.

### DESCRIPTION OF THE REFERENCES

I. Musical instrument
10. Cymbal
II. Connection hole
12. Inclined form

### DESCRIPTION OF THE INVENTION

In the detailed description provided herein, the inventive musical instrument (10) is described by means of examples only for clarifying the subject matter such that no limiting effect is imposed. In the description provided herein, a musical instrument structure (1) comprising two, three, four, five or more cymbals (10) to produce applause sound to be used in the category of percussion category in the music industry is disclosed.

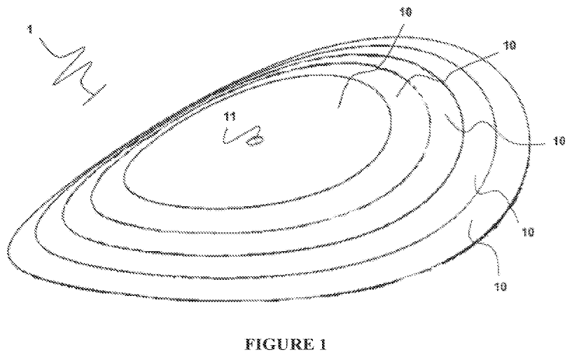

In FIG. 1, a perspective view of the model of the inventive musical instrument (1) structure consisting of five cymbals (10). Accordingly, the music instrument structure (1) comprises five cymbals (10) which are located on top of each other by means of being centered through the connection holes (11). Diameter dimensions of the cymbals (10) reduce from bottom to top. The cymbals (10) are in the inclined form (12), thus when they are hit with a drumstick, an effect sound is produced in the form of an applause sound every time they contact each other.

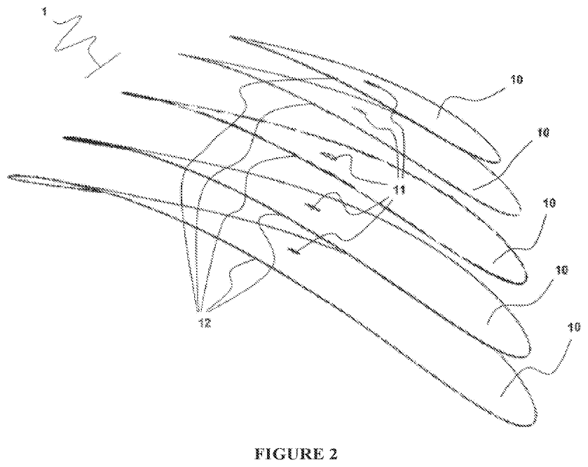

In FIG. 2, an exploded view of the model of the inventive musical instrument (1) structure consisting of five cymbals (10) is given. Thus, the inclined form (12) of the cymbals (10) can be seen more clearly. The angle and the parabolic value in the inclined form (12) are different from one model to another. However, this inclined form (12) and overlapping positioning of the cymbals (10) provide applause effect.

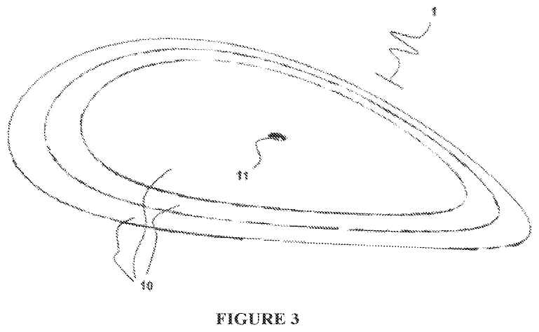

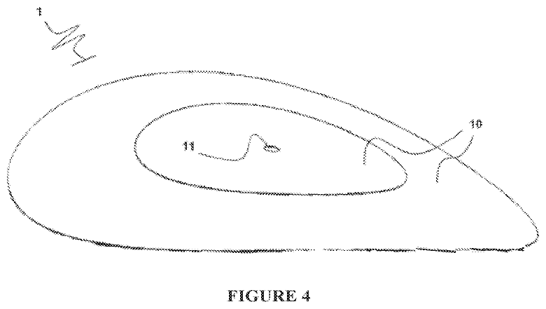

In FIG. 3, a perspective view of the model of the inventive musical instrument (1) structure consisting of three cymbals (10) is given, in FIG. 4, a perspective view of the model consisting of two cymbals (10) is given. The only difference of these models from the model comprising five cymbals (10) is the number of cymbals (10), they have inclined form (12) and they produce applause effect as a result of the contact of the cymbals (10) with each other. Although a model comprising four cymbals (10) is not shown in the figures, applause sound can also be produced by a musical instrument structure (1) comprising four or more cymbals (10).

A disc form is obtained by pouring bronze metal material melt raw material in the production of the inventive musical instrument structure (1). Subsequently, the cymbals (10) in the disc form are annealed in the annealing furnace. After it is annealed in the annealing furnace, the material in the form of paste is formed with the required length and thickness by subjecting the material to the rolling process. Subsequently, the hammer application is performed by the hammering technique. The sharpness formed on the edges is eliminated and a connection hole (11) is opened which enables the material to be played and matched as a normal cymbal (10) by placing it on a stand. The product, after being tested by the professional musicians, is tuned subsequent to the matching process and the desired applause sound is provided with an appropriate character.

What is claimed is:

1. A musical instrument structure (1) that produces applause sound effect to be used in the category of percussion instruments in the music sector, characterized in that; it comprises
at least two cymbals (10) that are located on top of each other by being centered through the connection holes (11) that are aligned such that the diameters of the cymbals (10) decrease from bottom to top,
an inclined form (12) that allows for overlapping the cymbals (10) with each other and for producing applause sound effect.

2. A musical instrument structure (1) according to claim 1, characterized in that; the angle of inclination and parabolic form of the inclined form (12) can be changed according to the tone of the required applause effect sound.

3. A musical instrument structure (1) according to claim 1, characterized in that; it comprises models with two, three, four and/or five cymbals (10) that are located on top of each other.

4. A musical instrument structure (1) according to claim 1, characterized in that; it comprises models with cymbals (10) more than five that are located on top of each other.
